(19) United States
(12) Patent Application Publication
(10) Pub. No.: US 2016/0193825 A1
(43) Pub. Date: Jul. 7, 2016

(54) ROLLER PRESS HAVING A STEPPED ROLLER

(71) Applicant: Kevin L. Corcoran, Mission Viejo, CA (US)

(72) Inventor: Kevin L. Corcoran, Mission Viejo, CA (US)

(21) Appl. No.: 14/983,304

(22) Filed: Dec. 29, 2015

Related U.S. Application Data
(60) Provisional application No. 62/100,302, filed on Jan. 6, 2015.

(51) Int. Cl. B41F 3/54

(52) U.S. Cl. CPC B41F 3/54

(57) ABSTRACT

A roller press having upper and lower rollers between which a die is moved so that a shape can be embossed into or cut from a sheet material carried by the die. One of the rollers (e.g., the upper roller) has a diameter which Varies along the length thereof so as to compensate or and reduce bowing of the roller and thereby enable a uniform pressure to he applied across the face of the die. The foregoing is achieved by manufacturing (e.g., molding) the upper roller with a plurality of stepped cylindrical roller pads lying side-by-side one another and having uniformly changing diameters which vary from one roller pad to the next. In particular, the cylindrical roller pad located at the middle of the upper roller has the widest diameter and the roller pads located at the opposite ends of the upper roller have the narrowest diameter.

### CROSS REFERENCES TO RELATED PATENT APPLICATIONS

This application is related to Provisional Patent Application No. 62/100,302 filed Jan. 6, 2015.

### BACKGROUND OF THE INVENTION

1. Field of the Invention

This invention relates to a roller press having, upper and lower rollers between which a die is moved so that a shape can be embossed into or cut from a sheet material that is carried by the die. One of the rollers (e.g., the upper roller) has a stepped diameter which varies along the length thereof so as to compensate for bowing of the roller and thereby enable a uniform pressure to be applied across the face of the die.

2. Background Art

Roller presses are known having an upper and a lower roller and means to be manually operated by a user in order to cause a die to be moved between the rollers. The rollers apply a compressive force to opposite faces of the die so that a shape can be embossed into or cut from a sheet material that is carried by the die. In a conventional roller press, each of the upper and lower rollers has a uniformly constant diameter along the length thereof. Depending upon the length of the rollers, the greatest pressure. (i.e., compressive force) is generated at the opposite ends of the rollers. Consequently, a non-uniform pressure is correspondingly applied to the opposite faces of the die which has been known to cause one or both of the rollers to bend or how at the middle. At the same time, the ability of the die to accurately emboss or cut the sheet material has been adversely affected.

Accordingly, it would be desirable to change the standard configuration of the upper or lower roller of the conventional roller press in order to compensate for and reduce the aforementioned bowing.

### SUMMARY OF THE INVENTION

In general terms, a roller press is described having upper and lower rotatable rollers between which a die is moved in response to the manual rotation of a crank handle. The rollers generate a compressive pressure to opposite faces of the die so that a shape can be embossed into or cut from a sheet material that is carried by the die. One of the upper and lower rollers (e.g., the upper roller) has a configuration which is advantageously adapted to cause a uniform pressure to he applied across the die as the die is rolled. between the rollers.

More particularly, the upper roller of the roller press is a stepped roller which has a diameter that decreases from the middle of the roller and longitudinally outward towards the opposite ends thereof. In this case, the stepped (e.g., upper) roller is widest at the middle and narrowest at the outer ends. In accordance with a preferred embodiment, the stepped roller is manufactured (e.g., molded) with a plurality of cylindrical roller pads lying side-by-side one another and having progressively changing diameters. In this case, the diameter of the roller pad at the middle of the stepped roller is the widest (e.g., 28.42 mm) of all of the roller pads. The diameters of the roller pads lying at opposite sides of the middle roller pad progressively decrease (e.g., by approximately 0.15 mm) from one pad to the next. By virtue of the progressively variable diameter of the stepped roller along the length thereof, a more uniform pressure will be applied by the upper and lower rollers of the roller press across the die so that a shape can be accurately embossed into or cut out of the sheet material carried by the die. Moreover, the upper and lower rollers are less likely to bend or bow at the center when compared to the rollers of conventional roller presses.

### BRIEF DESCRIPTION OF THE DRAWING

FIG. 1 shows a roller press having upper and lower rotatable rollers, wherein the upper roller has a stepped configuration in accordance with the present invention;

FIG. 2 is a cross-section of the roller press taken along lines 2-2 of FIG. 1;

FIG. 3 is a side view of the stepped upper roller from the roller press of FIG. 1; and

FIG. 4 is a cross-section of the stepped roller taken along lines 4-4 of FIG. 3.

### DESCRIPTION OF THE PREFERRED EMBODIMENT

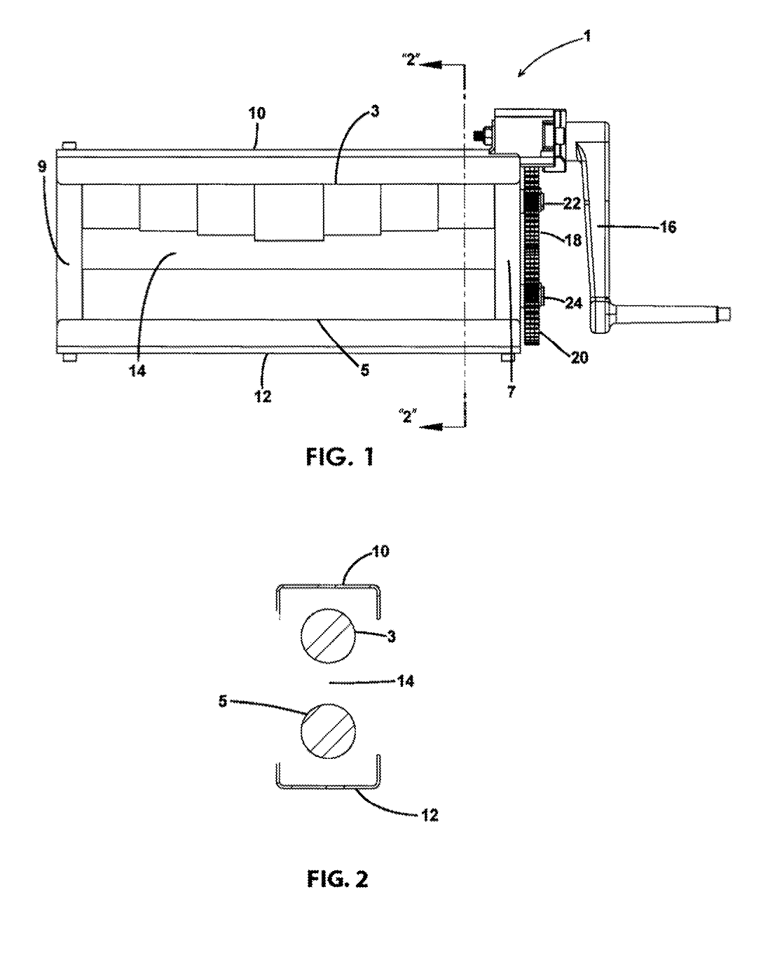

A roller press 1 having an stepped roller 3 is initially described while referring to FIG. 1 of the drawing& The roller press 1 is of the kind that has upper and lower rollers that extend laterally and horizontally thereacross between a pair of side posts 7 and 9. In the example shown in FIG. 1, the upper roller 3 is the stepped roller, the details and advantages of which will soon be explained. The lower roller 5 is a conventional cylindrical roller 5 having a constant diameter along the length thereof. However, it is within the scope of this invention for the upper roller 3 to have a constant diameter and the lower roller 5 to be the stepped roller.

The upper and lower rollers 3 and 5 are surrounded by top and bottom frames 10 and 12 of the roller press 1 and the side posts 7 and 9 located at opposite sides of the press 1. The upper and lower rollers 3 and 5 are arranged in spaced parallel alignment and separated from one another h a gap 14. The gap 14 is sized to receive therebetween a conventional die (not shown) which carries a sheet material (also not shown), whereby to impress shapes into or cut shapes from the sheet material in response to compressive pressures that are applied to opposite faces of the die by the upper and lower rollers 3 and 5.

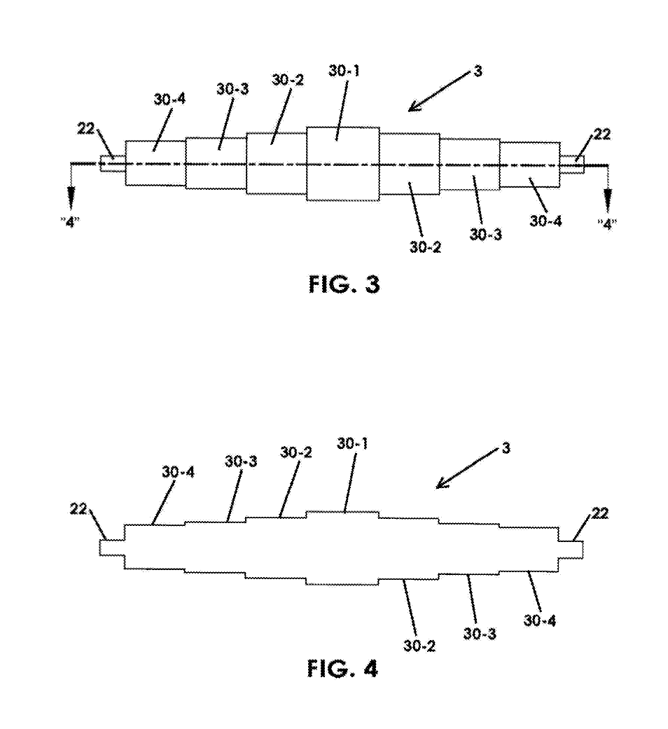

To this end, the roller press 1 includes a crank handle 16 which is coupled to the upper and lower rollers 3 and 5 by way of respective upper and lower rotatable, gear wheels 18 and 20. As is best shown in FIG. 3, each of the upper and lower rollers 3 and 5 has a respective pair of bearing posts 22 and 34 extending outwardly from the opposite ends thereof. The pairs of bearing posts 22 and 24 are received for rotation by hearing supports (not shown) at the side posts 7 and 9 at the opposite sides of the roller press 1. Thus, a rotational force applied by a user to the crank handle 16 is transmitted to the upper and lower rollers 3 and 5 via gear wheels 18 and 20 and one of the pair of bearing posts 22 and 24 from each roller. Accordingly, the upper and lower rollers 3 and 5 are rotated to correspondingly advance (i.e., roll) the die and sheet material through the gap 14 therebetween at which a compressive pressure is generated by the rollers against the die.

In accordance with the present invention, the stepped (upper) roller 3 of the roller press I has a configuration (i.e., shape) which is advantageously adapted to cause a uniform pressure to be applied across the die as the die is rolled through the gap 14 between the upper and lower rollers 3 and 5 in response to a rotation of the crank handle 16. Referring concurrently in this regard to FIGS. 1-4 of the drawings, the diameter of the stepped roller 3 decreases from the middle of the roller 3 and longitudinally outward towards the bearing posts 22 at the opposite ends thereof Therefore, the stepped roller 3 is widest at the middle and narrowest at the outer ends thereof adjacent the hearing posts 22.

More particularly, FIG. 3 shows a preferred embodiment for the stepped roller having a plurality of cylindrical roller pads lying side-by-side one another and having progressively changing diameters. In the case where the stepped roller 3 is manufactured from plastic, the roller can be molded so as to have the aforementioned plurality of stepped roller pads extending continuously one after the other along the longitudinal axis. Although the diameters of the roller pads will vary from one to the next, the length of each roller pad can he the same and will depend on the overall length of the roller 3.

By way of example, the diameter of the cylindrical roller pad 30-1 lying at the middle of the stepped roller 3 is 28.42 mm. the roller pads 30-2 lying on opposite sides of the roller pad 30-1 have a lesser diameter of 28.17 mm. Each of a pair of roller pads 30-3 lying adjacent the roller pads 30-2 has a still-lesser diameter of 27.91 mm. The outermost roller pads 30-4 lying adjacent the bearing posts 22 of roller 3 have the smallest diameter of 27.66 mm. The progression of changing diameters of the roller pads 30-1 . . . 30-4 from the widest to the narrowest starting at the middle of the stepped roller 3 and moving outwardly and in opposite directions therefrom is best illustrated in FIG. 4.

The number of roller pads 30-1 . . . 30-4 along the stepped roller 3 will depend on the sizes of the roller press I and die to be rolled therethrough. It may be appreciated that the diameters of the roller pads ideally vary uniformly by approximately 0.15 mm from one pad to the next. However, it is to he understood that the precise diameters of the roller pads 30-1 . . . 30-4 listed above and the variation of the diameters from one roller pad to the next are for purposes of example only and should not he regarded as to limitation of this invention.

By virtue of the stepped roller 3 having a diameter that progressively varies (i.e., decreases) along the roller pads 30-1 . . . 30-4 from the middle pad 30-1 to the outermost pads 30-4, a more uniform pressure will be applied by the upper and lower rollers 3 and 4 of the roller press 1 of FIG. 1 across a die which is rolled through the gap 14 between the rollers. That is to say, the stepped roller pads having the greatest diameter at the middle of the roller 3 compensate for and thereby minimize the bending or bowing that is otherwise likely to occur in conventional roller presses where a non-uniform pressure is often applied across the opposite faces of the die. Accordingly, a shape can be accurately and cleanly embossed into or cut out of a sheet material carried by the die.

1. A roller press including an upper roller and a lower roller that are rotated in response to a rotational force applied thereto so that a die is moved between the upper and lower rollers at which to receive a compressive pressure for impacting a sheet material carried by the die, wherein one of said upper or lower rollers has a shape which changes along the length thereof.

2. The roller press recited in claim 1, wherein the one of said upper or lower rollers has a diameter which changes along the length thereof.

3. The roller press recited in claim 2, wherein the diameter of the one of said upper or lower rollers is the widest at the middle thereof.

4. The roller press recited in claim 3, wherein the diameter of the one of said upper or lower rollers decreases from the middle of sad one roller and longitudinally outward towards the opposite ends thereof.

5. The roller press recited in claim 2, wherein the one of said upper or lower rollers has a plurality of cylindrical roller pads lying side-by-side one another along said one roller, a first of said roller pads haying a diameter which is different from the diameter of an adjacent roller pad.

6. The roller press recited in claim 5, wherein the diameter of the cylindrical roller pad located at the middle of the one of said upper or lower rollers is the widest among said plurality of roller pads, and the diameters of the cylindrical roller pads located at the opposite ends of said one roller are the narrowest.

7. The roller press recited in claim 6, wherein the diameter of the cylindrical roller pads located at the opposite ends of the one of said upper or lower rollers are identical.

8. The roller press recited in claim 6, wherein the diameter of said plurality of cylindrical roller pads varies substantially uniformly from one roller pad to the net along the length of the one of said upper or lower rollers.

9. The roller press recited in claim 6, wherein said plurality of cylindrical roller pads comprise a corresponding plurality of steps running continuously along the length of the one of said upper or lower rollers.

10. The roller press recited in claim 9, wherein said plurality of steps are molded into the one of said upper or lower rollers.
